(19) United States
(12) Patent Application Publication
(10) Pub. No.: US 2002/0100652 A1
(43) Pub. Date: Aug. 1, 2002

(54) Retractable cord assembly for use in marine vessels

(76) Inventor: Travis G. Loyd, Vienna, IL (US)

Correspondence Address: JENKENS & GILCHRIST, P.C., 225 WEST WASHINGTON, SUITE 2600, CHICAGO, IL, 60606, US

(21) Appl. No.: 09/867,859

(22) Filed: May 30, 2001

Related U.S. Application Data
(60) Provisional application No. 60/265,532, filed on Jan. 31, 2001.

(51) Int. Cl. H02G 11/00; H02G 11/02

(52) U.S. Cl. 191/12.2 R; 191/12.4

(57) ABSTRACT

A system for supplying power to a marine vessel that comprises at least one battery charger device, at least one battery and at least one retractable cord device. The battery charger device, the battery and the retractable cord device are releasably attached to and within the marine vessel. The battery charger device is connected to the battery and adapted to transmit voltage to the battery. The retractable cord device is connected to the battery charger device and is adapted to transmit voltage to the battery charger.

### CROSS-REFERENCE TO RELATED APPLICATION

This application claims benefit to U.S. Provisional Patent Application Serial No. 60/265,532, filed on Jan. 31, 2001, entitled “Marine Electrical Pathway Preferably With Retractable Cord”.

### FIELD OF INVENTION

The present invention is generally directed to a marine vessel having a retractable cord device. More specifically, the present invention is directed to a marine vessel having a retractable cord for conveying power for charging on-board batteries.

### BACKGROUND OF THE INVENTION

Fisherman, including bass fisherman, encounter many problems and difficulties other than the failure to catch fish. For example, fisherman often have problems with the maintenance of their equipment. The equipment used and maintained on marine vessels can vary widely.

Bass fisherman typically use a fishing boat that may include an electrical trolling motor that powers the boat when attempting to seek or lure actively feeding or attacking fish. To power the trolling motor of the bass fishing boat, batteries are typically employed. The batteries in a bass fishing boat are typically located under a seat lid in the rear (stern) of the boat. The batteries often require charging after a day of use.

To charge the batteries in existing bass fishing boats, the fisherman takes and plugs in an extension cord(s) to an electrical outlet that is connected to the battery charger and the batteries. After the batteries are charged, the fisherman must disconnect the extension cord(s), which may be tangled, from both the electrical outlet and the battery charger. The extension cord(s) then must be stored.

This process creates problems for the fishermen and is exacerbated for those many fishermen that compete in popular out-of-town tournaments. During these out-of-town tournaments, fishermen often stay at motels or the like and charge the batteries overnight after a full day of fishing. In the morning, the fisherman awake to a wet extension cord(s) and a wet seat lid that covers the batteries. The extension cord(s) and the battery charger must be disconnected and replaced in these less than ideal conditions. This often results in the fishermen getting wet and feeling uncomfortable. During these tournament conditions, this process of charging the batteries are often repeated for several days.

It would be desirable to eliminate or reduce such problems.

### SUMMARY OF THE INVENTION

A system for supplying power to a marine vessel that comprises at least one battery charger device, at least one battery and at least one retractable cord device. The battery charger device, the battery and the retractable cord device are releasably attached to and within the marine vessel. The battery charger device is connected to the battery and adapted to transmit voltage to the battery. The retractable cord device is connected to the battery charger device and is adapted to transmit voltage to the battery charger.

According to one process of the present invention, power is supplied to a marine vessel. The marine vessel comprises at least one battery charger device, at least one battery and at least one retractable cord device. The battery charger device, the battery and the retractable cord device are releasably attached to and within the marine vessel. The retractable cord device is connected to the battery charger device. The battery charger device is connected to the battery and adapted to transmit voltage to the battery. The retractable cord device comprises an retractable electrical cord. The retractable electrical cord is connected to an electrical receptacle. Voltage is supplied to charge the batteries from the electrical receptacle via the retractable cord device and the battery charger device. The retractable electrical cord is disconnected from the electrical receptacle and the retractable electrical cord automatically retracts to its location within the marine vessel.

Other objects and advantages of the invention will become apparent upon reading the following detailed description and upon reference to the drawings.

### BRIEF DESCRIPTION OF THE DRAWINGS

FIG. 1 is a top plan view of a stern portion of a sports fishing boat equipped with a battery, a battery charger device and a retractable cord device according to one embodiment of the present invention;

FIG. 2 is a front cut-away view of the retractable cord device;

FIG. 3 is a side view of a coil of FIG. 2;

FIG. 4 is a top, cut-away, detailed view of the retractable cord device;

FIG. 5 is a front, cut-away, detailed of the retractable cord device;

FIG. 6 is a top, cut-away detailed view of a brush assembly with in-line fuse, taken generally from circle 6 of FIG. 4;

FIG. 7a is a sectional view of the brush assembly taken generally along line 7a-7a of FIG. 6; and

FIG. 7b is a top view of the brush assembly of FIG. 7a.

While the invention is susceptible to various modifications and alternative forms, specific embodiments thereof have been shown by way of examples in the drawings and will herein be described in detail. It should be understood, however, that it is not intended to limit the invention to the particular forms disclosed but, on the contrary, the intention is to cover all modifications, equivalents and alternatives falling within the spirit and scope of the invention as defined by the appended claims.

### DETAILED DESCRIPTION OF THE ILLUSTRATED EMBODIMENT

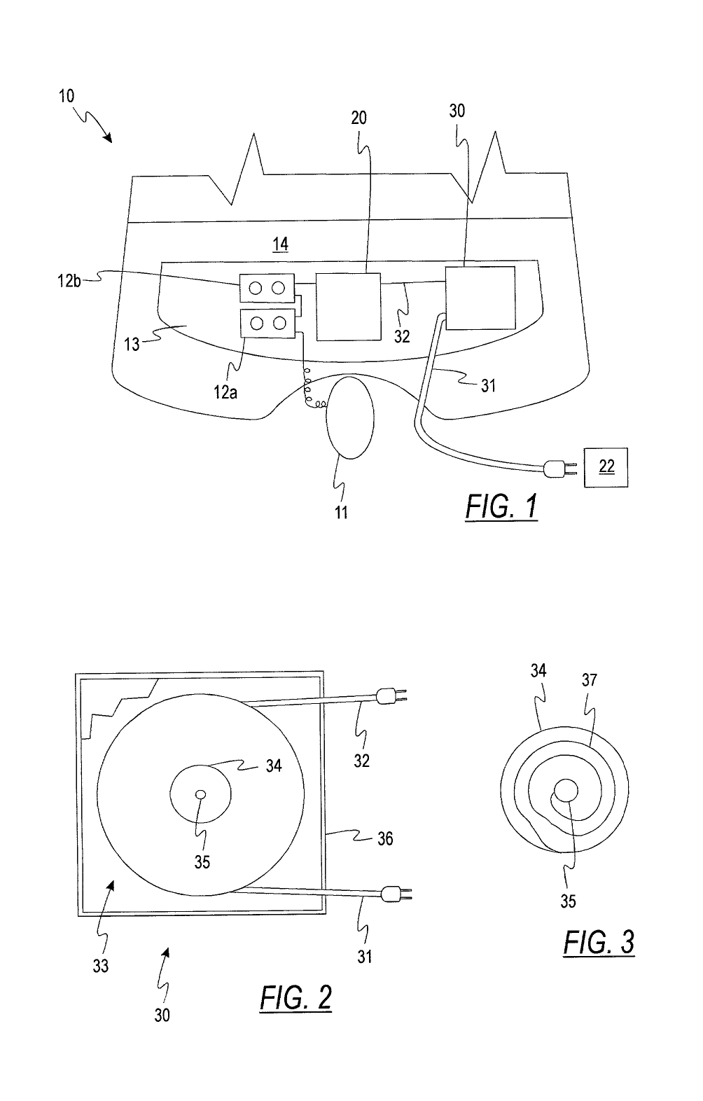

Referring now to the drawings, and initially to FIG. 1, a sport fishing boat or bass boat 10 is shown according to one embodiment. The boat 10 of FIG. 1 has an outboard gas-powered motor 11 at its stern and two batteries 12a and 12b. The battery 12a is in electrical communication with the gas-powered motor 11. The battery 12b is in electrical communication with, for example, an electrical trolling motor (not shown). The batteries 12 are installed in a stern bunker 13 seated in and under a top deck 14 of the boat 10. A deck lid (not illustrated) covers the bunker 13 and is generally flat with the top deck 14 of the boat 10. The boat 10 of FIG. 1 also includes a battery charger device 20 and a retractable cord device 30. The battery charger device 20 and the retractable cord device 30 are shown in FIG. 1 as being releasably attached within the stern bunker 13. The battery charger device 20 and the retractable cord device 30 are in electrical communication with the batteries 12, particularly on command for charging.

The battery 12b that is used to typically power the electrical trolling motor (not shown) is a 12-volt battery. One type of battery that may be employed is a 12 volt deep-cycle marine battery manufactured by Interstate. It is contemplated that other voltage batteries may be used to transmit voltage to the trolling motor, such as 6-volt batteries. The battery 12b may also supply power for other items on a boat including, but not limited to, external lights, radios, television and refrigerator devices. It is preferable that the battery 12b provides power to the trolling motor and may also supply power for other items. The cranking battery 12a supplies power to the gas-powered motor 11. It is contemplated that the boat 10 may have a different number of batteries 12 than depicted in FIG. 1. For example, the boat 10 may include one battery or three or more batteries to power one or more motor(s) of the boat. The electrical trolling motor is typically located in the bow of the boat 10. The trolling motor, however, may be located adjacent to the gas-powered motor 11.

The battery charger device 20 is used to transmit or carry voltage to the batteries 12. Specifically, the battery charger device 20 of FIG. 1 is used for transformation, reduction, changing phases or polarities of an electrical current before transmission to the batteries 12. One example of a battery charger device that may be employed is a dual bank or triple bank charger manufactured by Quest.

The electrical communication from the battery charger device 20 to the batteries 12 may be activated by a manual switch (not illustrated) such as a button-press, flip or toggle switch. Alternatively, a switch may be activated upon pulling out a retractable electrical cord 31 that is discussed below. The battery charger device 20 may be releasably attached to the boat 10 by methods such as by bolting, screwing, gluing, welding and the like. It is preferably that the battery charging device 20 be releasably attached within the stern of the boat 10. It is contemplated that the boat 10 may have more than one battery charger device 20. The battery charger device 20 is shown separately from the batteries 12 in FIG. 1, but the battery charger device and the batteries may be an integral assembly.

According to one embodiment, the retractable cord device 30 of FIGS. 2-7 is depicted. The retractable cord device 30 comprises a retractable electrical cord 31, a transmission electrical cord 32, a wheel 33 and a coil spring 37. The retractable electrical cord 31 may vary in length, but is generally from about 50 to about 75 feet in length. The retractable electrical cord 31 may be made from a variety of suitable materials including, but not limited to, 12-gauge wire. The retractable electrical cord 31 has an extension (e.g., a male plug) adapted to fit into an electrical receptacle 22 (see FIG. 1) such as a 120-voltage source or a 220-voltage source. The retractable electrical cord 31 may be extended from the top of the bunker 13 with the deck top lid removed or loosened or, alternatively, the cord 31 may be threaded through the hull of the boat 10 or top deck 14. If the electrical cord 31 is threaded through the hull of the boat 10 or top deck 14, a waterproof seal may be provided to tightly embrace the cord 31 and prevent or inhibit water from entering into the boat.

The retractable cord device 30 is shown in, for example, FIG. 2 as being encompassed by an outer housing 36. The outer housing 36 may be made of various materials. For example, the outer housing 36 may be made of a durable plastic material that is preferably waterproof. Alternatively, the outer housing 36 may be made of a suitable metallic material. It is not necessary for the retractable cord device to have an outer housing, but it is preferably to eliminate or reduce water from entering the device.

The transmission electrical cord or wire 32 is shown in FIG. 1 as connecting to the battery charger device 20 from the retractable electrical cord 31. The transmission electrical cord 32 typically has a extension (e.g., a female plug) that corresponds with a connection of the battery charger device 20. The transmission electrical cord 32 assists in transmitting voltage from the electrical receptacle to the battery charger device 20.

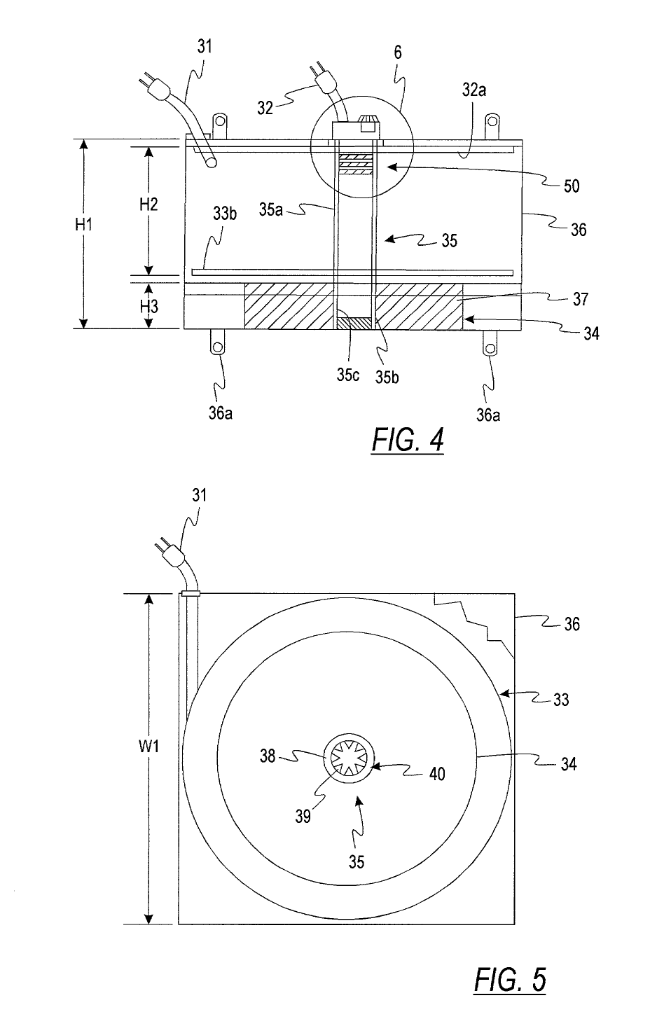

Referring to FIGS. 2 and 4, the retractable electrical cord 31 is wound on the wheel 33 and, more specifically, an outer surface 35a of a central axle assembly 35. The central axle assembly 35 extends from about end 33a through end 33b of the wheel 33. The central axle assembly 35 rotates to wind and unwind the retractable cord 31 from the wheel 33. It is preferred to have the retractable electrical cord 31 in its retracted position (i.e., wound on the wheel 33) when not charging the battery charger device 20 so as to provide a neater and safer environment.

Referring to FIGS. 3 and 4, a foundation spool 34 is located beneath the end 33b of the wheel 33, The central axle assembly 35 extends into at least a portion of the foundation spool 34. The foundation spool 34 houses the coil spring 37 that assists in automatically retracting the electrical cord 31 by providing rewinding force. The coil spring 37 is wound around an outer surface 35b of the central axle assembly 35. The electrical cord 31 is preferably located so as to assist the coil spring 37 in the retraction thereof.

The central axle assembly 35 of FIG. 5 includes a spool bearing track 38, spool bearings 39 and a centrifugal clutch assembly 40. The outer portion 35a of the central 10 axle assembly 35 rotates in winding the retractable electrical cord 31. Inner portion 35c of the central axle assembly 35 as will be described below does not rotate. The spool bearing track 38, spool bearings 39 and the clutch assembly 40 assist in providing less friction on the coil spring 37 that results in a smoother rotation of the central axle assembly 35. The spool bearing track 38, spool bearings 39 and the clutch assembly 40 is also assist in reducing the wear on the central axle assembly 35.

The dimensions of the spool bearing track 38 and the spool bearings 39 may vary. For example, spool bearing track 38 may have about a 1 ½ inch inner diameter and an outer diameter of about 2 inches. One example of a spool bearing 39 that may be used is a ¼ inch ball or needle bearing. It is contemplated that other sized spool bearing tracks and spool bearings may be used in the central axle assembly 35.

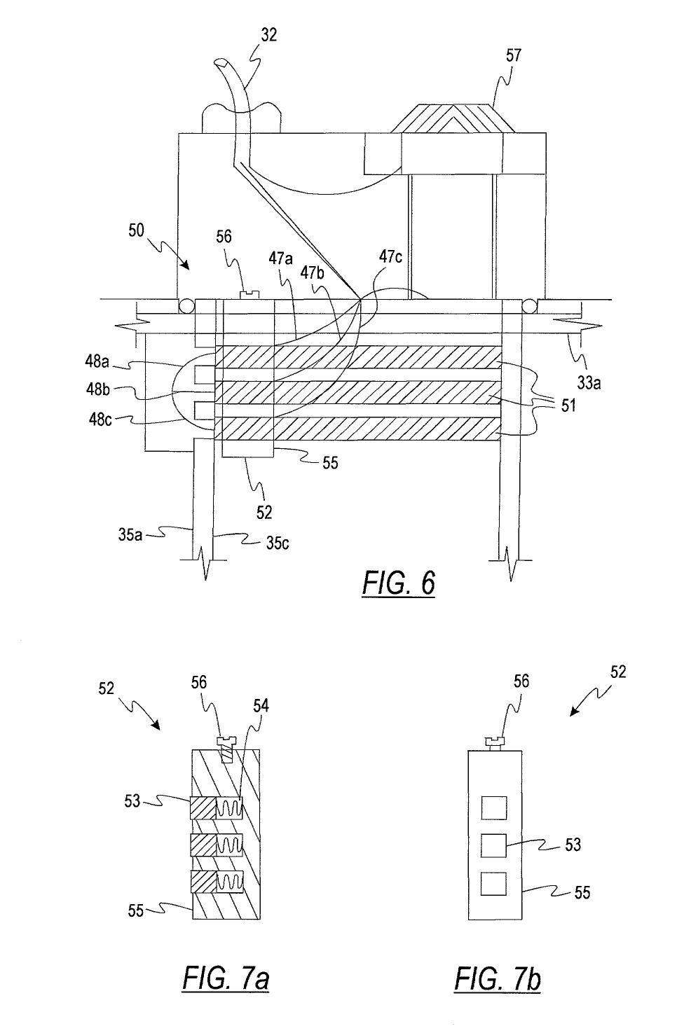

Referring to FIGS. 6 and 7, the retractable cord device 30 includes an optional brush track assembly 50 that is contained in housing 55. The brush track assembly 5O includes a plurality of electrical brushes 51 and an electrical brush assembly 52. The electrical brush assembly 52 includes a plurality of electrical brush contacts 53 and a plurality of brush contact springs 54. The brush track assembly 50 assists in preventing or inhibiting sparking that may occur, for example, from the unhooking of the electrical connection. This is accomplished by providing constant tension of the electrical brush assembly 52 with the electrical brush assembly 51 so as to be an electrical conductor.

The plurality of electrical brushes 51 may be made of copper strips that are attached to the inner surface 35c. The electrical brush assembly 52 may be made of carbide spray-loaded brushes. The brush assembly 50 connects the wires from the transmission electrical cord 32 and the wires from the retractable electrical cord 31. In the embodiment depicted in FIG. 6, three wires (positive, ground, and neutral) 47a-c and 48a-c are shown respectively for both the transmission electrical cord 32 and the retractable electrical cord 31. It is contemplated that more or less wires may be used in the transmission electrical cord 32 and/or the retractable electrical cord 31. It is also contemplated that the electrical cord 31 may be directly connected to the transmission cord 32 without the electrical brush assembly 52.

The brush track assembly 52 also includes a fastener or set screw 56 that assists in securing the wires 47a-c and 48a-c from the retractable electrical cord 31 and the transmission electrical cord 32. The set screw 56 also secures the brush track assembly 50 within the retractable cord device 30. The retractable cord device also includes an optional in-line fuse with fuse casting 57 to assist in preventing or inhibiting unwanted electrical surges or the like from damaging the battery charger device 20 or the batteries 12.

It is contemplated that the retractable cord device 30 described above may be made in a different manner than described in detail above in conjunction with FIGS. 2-7. The retractable cord device 30 may be made with spools of different mechanical and/or electrical parts.

Several dimensions of the retractable cord device 30 are depicted in FIGS. 4 and 5. Specifically, in FIG. 4, height Hi is about 8 inches, height H2 is about 6 inches and height H3 is about 2 inches, while in FIG. 5, the width W1 is about 14 inches. The retractable cord device 30 may be made of different suitable sizes and/or shapes than depicted in FIGS. 2-7. Similarly, the component parts of the retractable cord device 30 also may be made of different suitable sizes and/or shapes than depicted in FIGS. 2-7.

The retractable cord device 30 may be releasably attached to the boat 10 by methods such as by bolting, screwing, gluing, welding and the like. For example, the retractable cord device 30 is shown in FIG. 4 as being releasably attached to the boat 10 via the use of a plurality of anchor brackets 36a in conjunctions with screws (not shown). It is preferably that the retractable cord device be releasably attached within the hull of the boat 10.

According to one process of supplying power to a marine vessel, the marine vessel comprises at least one battery charger device, at least one battery and at least one retractable cord device such as depicted in FIG. 1. The battery charger device, the battery and the retractable cord device are releasably attached to and within the marine vessel. The retractable cord device is connected to the battery charger device. The battery charger device is connected to the battery and adapted to transmit voltage to the battery. The retractable cord device comprises an retractable electrical cord. The retractable electrical cord is connected to an electrical receptacle. Voltage is supplied to charge the batteries from the electrical receptacle via the retractable cord device and the battery charger device. The retractable electrical cord is disconnected from the electrical receptacle and the retractable electrical cord automatically retracts to its location within the marine vessel.

The system and process of the present invention may be adapted to various marine vessels or crafts. For example, the marine vessels may include elaborate vessels such as yachts or large cabin cruisers. The marine vessels may include more modest vessels such as an open runabout, skiff, dingy or canoe. More typically, the present invention is adapted for use in marine vessels that are sports fishing boats including, but not limited to, bass fishing boats.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A system for supplying power to a marine vessel, the system comprising at least one battery charger device, at least one battery and at least one retractable cord device, the battery charger device, the battery and the retractable cord device being releasably attached to and within the marine vessel, the battery charger device being connected to the battery and adapted to transmit voltage to the battery, the retractable cord device being connected to the battery charger device and being adapted to transmit voltage to the battery charger.

2. The system of claim 1, wherein the marine vessel is a sport fishing boat.

3. The system of claim 2, wherein the sport fishing boat is a bass fishing boat.

4. The system of claim 1, wherein the battery charger device, the battery and the retractable cord device are located in a bunker in a stern portion of the marine vessel.

5. The system of claim 4, wherein the bunker of the marine vessel is covered by a deck lid.

6. The system of claim 1, wherein the battery charger device and the battery are an integral assembly.

7. The system of claim 1, wherein the retractable cord device is adapted to transmit voltage from a 110 voltage source.

8. The system of claim 1, wherein the retractable cord device is adapted to transmit voltage from a 220 voltage source.

9. The system of claim 1, wherein the battery is adapted to supply power to a motor that powers the marine vessel.

10. The system of claim 9, wherein the motor is an electrical trolling motor adapted to power a sport fishing boat.

11. The system of claim 1, wherein the retractable cord device includes an electrical cord that adapted to retract via a coil spring.

12. The system of claim 11, wherein the retractable cord device further includes a brush track assembly.

13. A process of supplying power to a marine vessel, the process comprising;
providing a marine vessel comprising at least one battery charger device, at least one battery and at least one retractable cord device, the battery charger device, the battery and the retractable cord device being releasably attached to and within the marine vessel, the retractable cord device being connected to the battery charger device, the battery charger device being connected to the battery and adapted to transmit voltage to the battery, the retractable cord device comprising an retractable electrical cord;
connecting the retractable electrical cord to an electrical receptacle;
supplying voltage to charge the batteries from the electrical receptacle via the retractable cord device and the battery charger device; and
disconnecting the retractable electrical cord from the electrical receptacle, the retractable electrical cord automatically retracting to its location within the marine vessel.

14. The process of claim 13, wherein the electrical receptacle supplies 110 volts.

15. The process of claim 13, wherein the electrical receptacle supplies 220 volts.

16. The process of claim 13, wherein the marine vessel is a sport fishing boat.

17. The process of claim 13, wherein the battery is adapted to supply power to a motor that powers the marine vessel.

18. The process of claim 17, wherein the motor is an electrical trolling motor adapted to power a sport fishing boat.
